(19) United States
(12) Patent Application Publication
(10) Pub. No.: US 2015/0154699 A1
(43) Pub. Date: Jun. 4, 2015

(54) Alternate-Form Options

(71) Applicant: Chicago Mercantile Exchange Inc., Chicago, IL (US)

(72) Inventors: John Labuszewski, Westmont, IL (US); John Kerpel, Chicago, IL (US); John Nyhoff, Darien, IL (US); Lori Aldinger, Naperville, IL (US)

(73) Assignee: Chicago Mercantile Exchange Inc., Chicago, IL (US)

(21) Appl. No.: 14/096,590

(22) Filed: Dec. 4, 2013

(51) Int. Cl. G06Q 40/04

(52) U.S. Cl. CPC G06Q 40/04

(57) ABSTRACT

Option class definition data may indicate a negotiable parameter and a plurality of non-negotiable parameters. The negotiable parameter may be an optioned transaction parameter, a strike price parameter, a put-or-call type parameter, an expiration parameter or an exercise style parameter. Buy order data and sell order data may indicate values for the negotiable parameter. Matching buy orders and sell orders may be identified based on values for the negotiable parameter indicated by the buy order data and the sell order data.

### BACKGROUND

An option is an undertaking by which a first party has the right, but not the obligation, to require a second party to enter into an optioned transaction at some future time. That second party has an obligation to enter into that optioned transaction if the first party exercises its right. The first party may be called the “receiver,” “buyer,” “holder” or “bearer” of the option. The second party may be called the “grantor,” “seller” or “writer” of the option. An option grantor will often receive a payment or some other value in return for granting that option. Similarly, an option buyer often makes some payment or otherwise provides value in return for receiving the option.

Optioned transactions can take many forms. For example, an optioned transaction may be the sale of a financial instrument (e.g., a stock, a bond, a government-issued obligation), the sale of some quantity of a physical good (e.g., some agricultural or industrial commodity) or the sale of some other type of underlying subject matter. A holder of an option in this example may have the right to require the option grantor to sell (or buy) the underlying subject matter, at a predefined future time, at a predefined price. As another example, an optioned transaction may be the entry into a futures contract or some other type of subsequent agreement. A holder of an option in this example may have the right to require the option grantor to sell (or buy) a particular type of futures contract, at a predefined future time, at a predefined price. There are numerous other types of optionable transactions.

Options normally have certain terms. One of those terms, of course, specifies the optioned transaction. Another of those terms is the premium. The premium is the value provided by an option buyer for a received option. Typically, the option buyer provides that value, directly or indirectly, to the option seller as consideration for granting the option.

Another option term is the option type, i.e., whether the option is a “call” or a “put.” In a call option, the option holder normally has the rights of a buyer under the optioned transaction. Conversely, the grantor of a call option normally has the rights of a seller under the optioned transaction. For a call option in a futures contract, the optioned transaction is a futures contract as specified in the option. The call option holder has the right to buy that futures contract on specified terms at a specified time. As is commonly understood, a buyer of a futures contract takes a “long” position and agrees to pay the futures contract price in return for future delivery of the underlying subject matter of the futures contract. The grantor of a call option in a futures contract has the obligation (upon option exercise) to sell that futures contract on specified terms at a specified time. As is also commonly understood, a seller of a futures contract takes a “short” position and agrees to receive the futures contract price in return for delivering that underlying subject matter of the futures contract.

In a put option, the option holder normally has the rights of a seller under the optioned transaction. A put option grantor normally has the rights of a buyer under the optioned transaction. If the optioned transaction is a futures contract, a put option holder has the right to sell a specified futures contract on specified terms at a specified time. A grantor of a futures contract put option has the obligation (upon option exercise) to buy the specified futures contract on specified terms at a specified time.

Another option term is the exercise or “strike” price. The strike price may represent a price to be paid if the optioned transaction goes forward. For a futures contract call option, the strike price is the amount that the option holder agrees to pay for the optioned futures contract if the option is exercised. A grantor of a futures contract call option receives that strike price for the futures contract if the option is exercised. For a futures contract put option, the strike price is the amount that the option holder agrees to receive for the optioned futures contract if the option is exercised. A grantor of a futures contract put option agrees to pay the strike price, if the option is exercised, in return from the optioned futures contract.

A further option term is the expiration. An option expiration indicates a specific date, and/or a specific time on a specific date, after which the option is no longer valid. Prior to expiration, an option may be exercised. After expiration, an option is considered expired and is no longer exercisable. The relationship between option exercise and option expiration can be defined in various ways. For example, “American style” options may allow exercise of an option at any time prior to expiration. “European style” options may only allow exercise at expiration or within a narrow time window preceding expiration.

Options may be multilaterally traded through an exchange. For example, an exchange may define a particular kind of option based on the optioned transaction, the option type, the option strike price, the option expiration date and the option exercise style. Parties wishing to buy or sell that kind of option may then do so through negotiation of a premium. In particular, the exchange may receive buy orders from parties wishing to buy options, with each of those buy orders indicating a kind of option defined by the exchange and which those parties wish to receive. Each of those buy orders may further indicate the premium that the buy order submitter is willing to pay. The exchange may also receive orders from other parties wishing to sell options, with each of those sell orders indicating the exchange-defined kind of option and the premium that the sell order submitter is willing to accept. The exchange may then anonymously match buy orders against sell orders based on the premium amounts indicated in the orders.

### SUMMARY

This Summary is provided to introduce a selection of concepts in a simplified form that are further described below in the Detailed Description. This Summary is not intended to identify key or essential features of the invention.

In at least some embodiments, option class definition data may be stored. That option class definition data may indicate a negotiable parameter, a plurality of non-negotiable parameters and values for the non-negotiable parameters. The negotiable parameter may be a parameter from a parameter group that consists of an optioned transaction parameter, a strike price parameter, a put-or-call type parameter, an expiration parameter and an exercise style parameter. The non-negotiable parameters may include a premium parameter and the members of the parameter group that are not the negotiable parameter. Buy order data and sell order data may be received. The buy order data may correspond to one or more buy orders, may indicate availability to receive one or more options in conformance with the option class definition data, and may indicate one or more values for the negotiable parameter. The sell order data may correspond to one or more sell orders, may indicate availability to grant one or more options in conformance with the option class definition data, and may indicate one or more values for the negotiable parameter. Matching buy orders and sell orders may be identified based on values for the negotiable parameter indicated by the buy order data and the sell order data. Data indicating execution of options corresponding to the matched buy orders and sell orders may be transmitted.

Embodiments include, without limitation, methods for processing data associated with options, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing trading systems and methods according to at least some embodiments.

FIGS. 2A through 2H are block diagrams showing operations performed by an exchange computer system in connection with options according to some embodiments.

FIG. 3 is a flow chart showing steps performed in methods according to at least some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

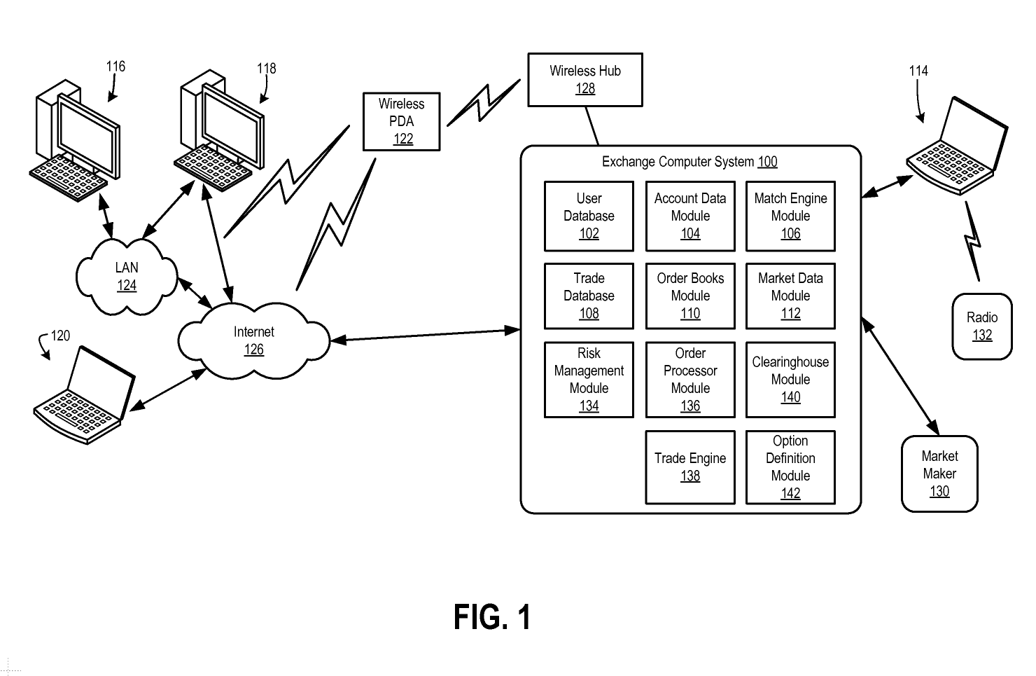

Aspects of at least some embodiments can be implemented with computer systems and computer networks that allow users to communicate trading information. An exemplary trading network environment for implementing systems and methods according to at least some embodiments is shown in FIG. 1. The implemented systems and methods can include systems and methods, such as are described herein, that facilitate data processing and other activities associated with options.

Computer system 100 can be operated by a financial product exchange and configured to perform operations of the exchange for, e.g., trading and otherwise processing various financial products. Financial products of the exchange may include, without limitation, futures contracts, options on futures contracts (“futures contract options”), other types of options, and other types of derivative contracts. Financial products traded or otherwise processed by the exchange may also include over-the-counter (OTC) products such as OTC forwards, OTC options, etc. In at least some embodiments, and as explained in more detail below, financial products traded and/or otherwise processed through exchange computer system 100 include options such as those described herein.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out operations of a clearinghouse of the exchange that operates computer system 100. Module 140 may receive data from and/or transmit data to trade database 108 and/or other modules of computer system 100, including option definition module 142, regarding trades of futures contracts, futures contracts options, and other financial products traded through the exchange that operates system 100. Clearinghouse module 140 may facilitate the financial product exchange (or a clearinghouse of the exchange) acting as one of the parties to every traded contract or other product. For example, computer system 100 may match an offer by party A to sell a futures contract, an option or another exchange-traded financial product with a bid by party B to purchase a like exchange-traded financial product. Module 140 may then create an exchange-traded financial product between party A and the exchange clearinghouse and a second exchange-traded financial product between the exchange clearinghouse and party B. Module 140 may similarly create offsetting contracts when creating contracts as a result of an option exercise. Module 140 may also be configured to perform other clearinghouse operations. As a further example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of delivery and other final settlement obligations, etc.

Option definition module 142 generates, stores and processes data regarding option definitions. Various operations performed by option definition module 142 in at least some embodiments are further described below. As also discussed below, operations associated with options may also and/or alternatively be performed by other modules of system 100.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 142 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems and fee systems.

The operations of computer devices and systems shown in FIG. 1 may be controlled by computer-executable instructions stored on non-transitory computer-readable media. For example, computer device 116 may include computer-executable instructions for receiving market data from exchange computer system 100 and displaying that information to a user. As another example, module 142 and/or other modules of exchange computer system 100 may include computer-executable instructions for performing herein-described operations associated with options.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “system 100”) receives, stores, generates and/or otherwise processes data associated with classes of options as described herein. For convenience, these options will be referred to as alternate-form options. Throughout this description, “option” is distinguished from “option class.” “Option” refers to a contract that is created, or “executed,” when two parties have agreed to assume responsibilities of option receiver and option grantor. The parties may reach that agreement bilaterally or, as described below, multilaterally through an exchange. “Option class” (or “class of options”) refers to a category of options for which some of the following terms are the same: optioned transaction, option type, option strike price, option exercise style, option expiration date and option premium. In at least some embodiments, an option class refers to a category of options for which all but one of those terms is the same. Option execution is also distinct from option exercise. Option execution refers to the creation of an option contract, while option exercise refers to the exercise of rights under that executed option by the option holder.

As explained below in further detail, alternate-form options are options in which a term other than option premium is used as the basis for option negotiation. For example, system 100 may generate and store option definition data that indicates the negotiable and non-negotiable parameters for a particular class of alternate-form option that may be traded through an exchange that operates system 100. Each of those parameters may correspond to a term applicable to every option in the defined option class. The option definition data may further include values for the non-negotiable parameters. In some embodiments, the option premium may be a non-negotiable parameter and the definition data may include a value for the premium parameter that applies to all options in the defined option class. In some such embodiments, the strike price may be a negotiable parameter. In at least some of those embodiments, orders to buy or sell such alternate-form options may specify a strike price the ordering party will accept. In other embodiments, expiration may be a negotiable parameter, and orders to buy or sell such alternate-form options may specify an expiration that the ordering party will accept. In still other embodiments, option type (e.g., put or call) may be a negotiable parameter. In yet other embodiments, exercise style or expiration date may be a negotiable parameter.

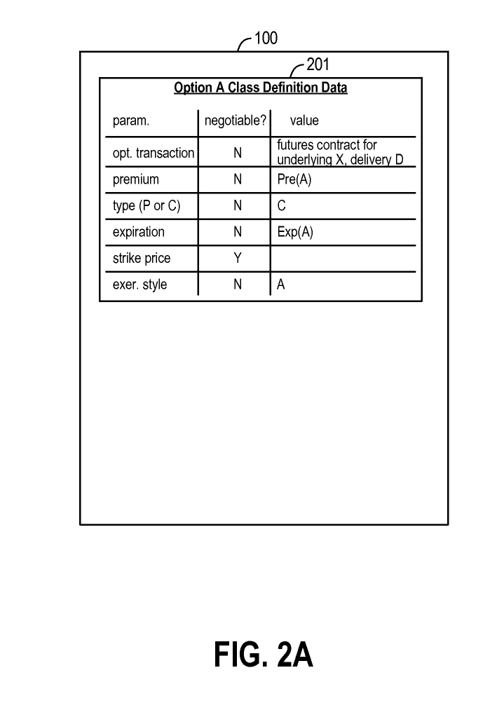

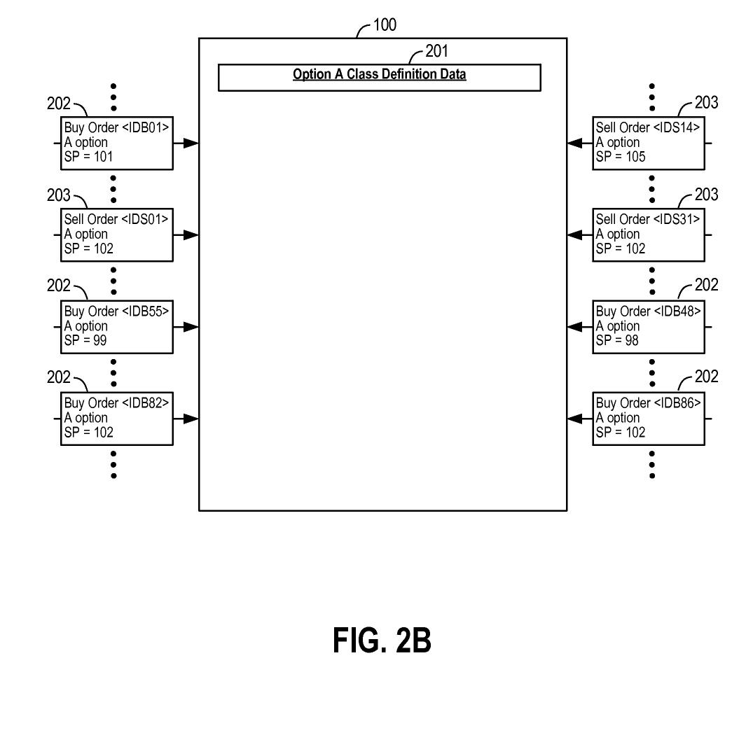

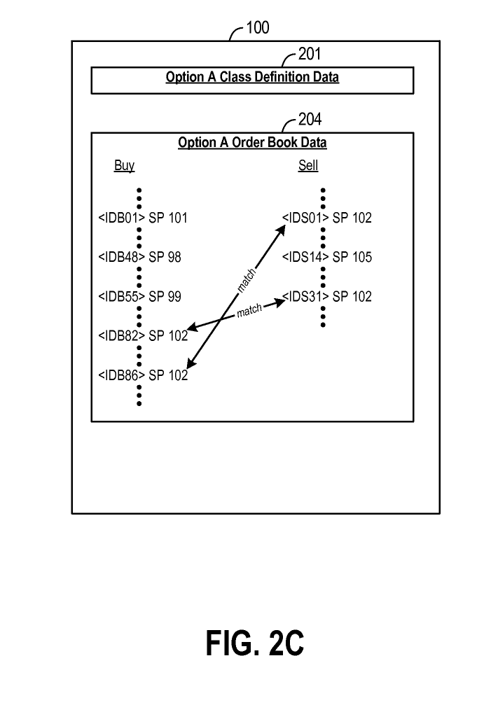

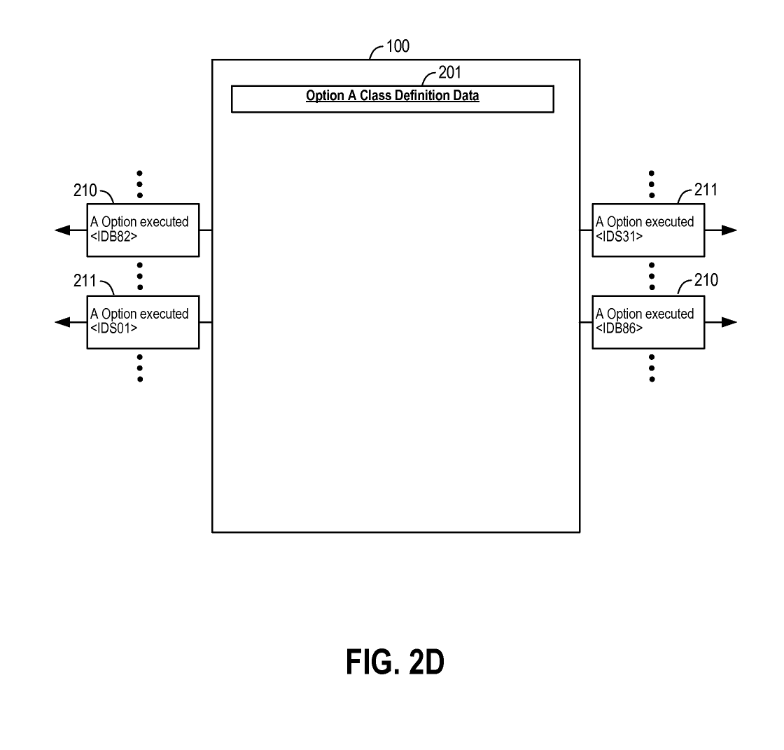

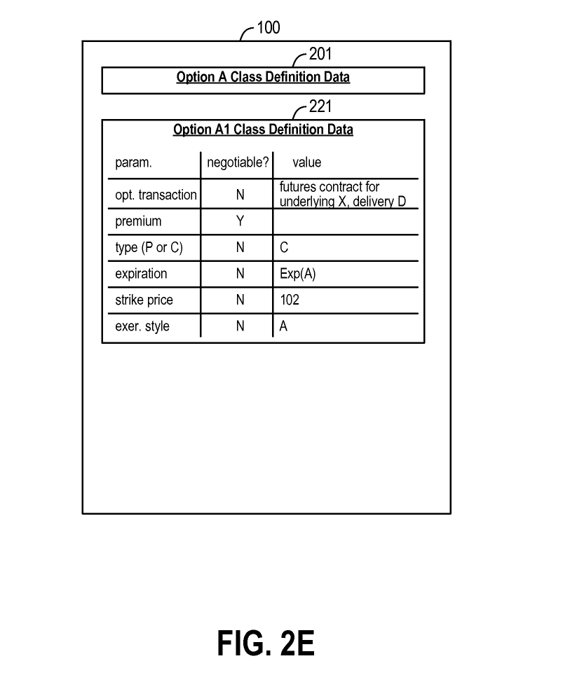

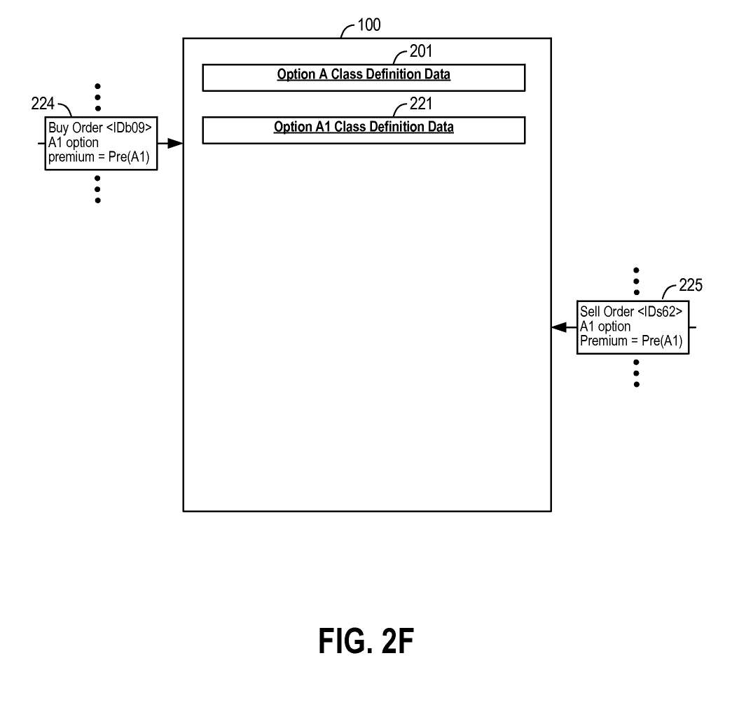

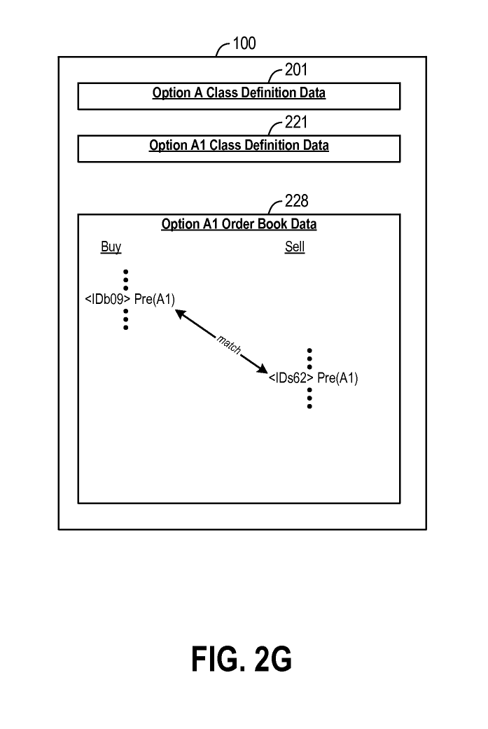

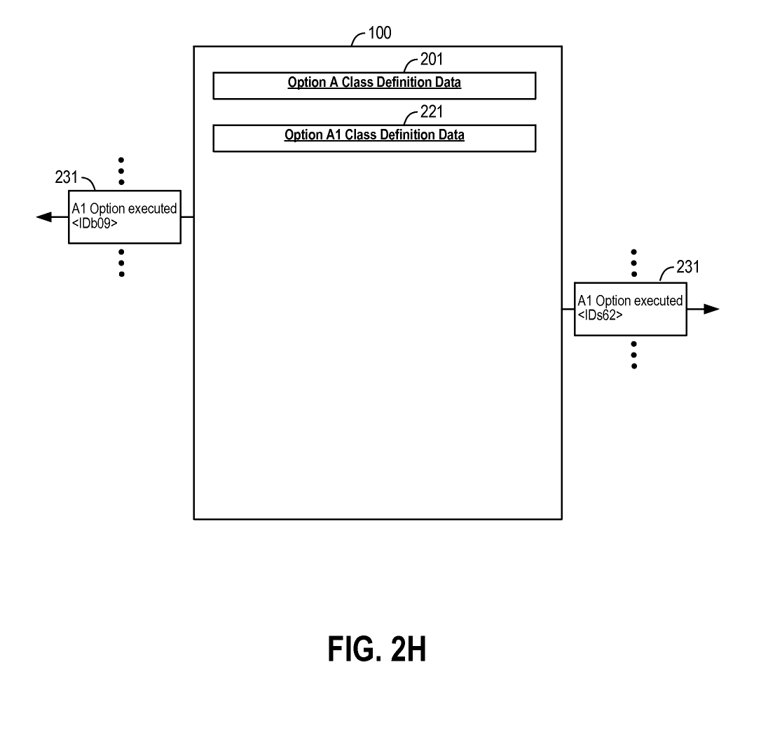

FIGS. 2A through 2H are block diagrams showing operations performed by exchange computer system 100 in connection alternate-form options according to at least some embodiments. Although the below description may refer to performance of operations by specific modules of system 100, in other embodiments one or more of such operations may be performed by different modules and/or by a computer system that is not an exchange computer system.

To simplify explanation, the operations of FIGS. 2A through 2H are described using a single hypothetical class of alternate-form option. In particular, a hypothetical “A option” class definition is used for purposes of explanation. An option conforming to the A option class definition, i.e., an executed option contract between two parties that has the attributes specified by the A option class definition, will be referred to simply as an “A option.” The A option class definition is only one example. As will be explained in further detail below, numerous other classes of alternate-form options can be defined and operations performed in connection with such other option classes.

FIG. 2A shows operations performed by system 100 in connection with storing data defining the A option class. In particular, option definition module 142 stores option A class definition data 201. Data 201 includes data for each of multiple parameters, with each of those parameters corresponding to a term applicable to all A options. For each of the parameters, definition data 201 indicates whether that parameter is negotiable or non-negotiable. As used herein, a negotiable parameter indicates that the value of the corresponding option term may be the basis of an agreement between parties to execute an option, and that can be used as basis for matching an order of a party wishing to buy an option with an order of a party wishing to sell an option. A non-negotiable parameter indicates that the corresponding option term has a value that is defined by the option class definition and that applies to all options of that class. As described in further detail below, a parameter value may be defined in absolute or relative terms.

The first parameter shown in FIG. 2A (“opt. transaction”) corresponds to the optioned transaction term for all A options. This parameter is not negotiable (“N”) in the present example. The value of this parameter includes the specifics of the optioned transaction in an A option. In the current example, that optioned transaction is a specified type of futures contract. In particular, the optioned transaction is a futures contract for a specified underlying (“X”) and having a specified delivery date (“D”). The terms “X” and “D” are used in the present example for convenience, but are intended represent an actual underlying and an actual date that would be constant for all optioned transactions of A options. The “X” underlying could be a commodity (e.g., an agricultural, energy, metal or other type of commodity), a government-issued security (e.g., a United States Treasury Bill or Note), a non-government security (e.g., a stock of a corporation), a currency, a market index, or some other subject matter. The optioned transaction parameter definition could be, e.g., a pointer to memory location elsewhere in system 100 that contains a definition of a type of futures contract traded through system 100.

The second parameter shown in FIG. 2A (“premium”) corresponds to the premium term for all A options. This parameter is also not negotiable (“N”). The value of this parameter, shown generically for convenience as “Pre(A),” represents an amount that an A option buyer pays to obtain, and that an A option seller receives for granting, an A option. Pre(A) represents an actual premium value that would apply to all A options. The Pre(A) value could be defined in absolute terms, e.g., as a specific amount of a specific currency that would remain constant for all A options. Pre(A) value could alternatively be defined in relative terms. For example, this value could be defined as specified percentage of the value at which X futures contracts for D delivery are trading as of the time that an A option is executed.

The third parameter shown in FIG. 2A (“type (P or C)”) corresponds to the type term for all A options. In the current example, this parameter is not negotiable (“N”). The value of this parameter simply indicates whether A options are put options (“P”) or call options (“C”). In the present example, the term parameter has a value of “C.”

The fourth parameter shown in FIG. 2A (“expiration”) corresponds to the expiration term for all A options. This parameter is also non-negotiable (“N”) in the present example. For convenience, FIG. 2A shows the value of this parameter as “Exp(A),” which represents an actual expiration value that would apply to all A options. The Exp(A) value could be defined in absolute terms, e.g., as a specific date and time. The Exp(A) value could alternatively be defined in relative terms. For example, the value could be defined as a date that is a specified number of days after an A option is entered.

The fifth parameter shown in FIG. 2A (“strike price”) corresponds to the strike price term for all A options. This parameter is negotiable (“Y”) in the present example. Because the strike price parameter is negotiable, definition data 201 does not indicate a value for the parameter. However, definition data 201 could include data indicating whether orders for A options should specify a strike price in absolute or relative terms. An order specifying a strike price in absolute terms could include a specific price value (e.g., in dollars) that the party submitting the order will accept. For simplicity, the example of FIGS. 2A-2H assumes that definition data 201 indicates that option A orders should specify strike price in absolute terms.

An order specifying a strike price in relative terms could include a specific percentage of, or some incremental amount in addition to, some reference value. Although that reference value would be defined by the option class definition data, a value for the strike price parameter would not be defined, as that value would ultimately depend on a value to be submitted as part of an order. As one example of strike price specification in relative terms, the option class definition data could specify the reference value as the trading price, as of the time an option conforming to the class definition is executed, for other futures contracts that are like the defined optioned transaction. For instance, Option A definition data 201 could alternatively indicate that orders for A options should specify strike price as an incremental value to be paid in addition to the trade price, as of time of option A execution, for D delivery X futures contracts.

The sixth parameter shown in FIG. 2A (“exer. style”) corresponds to the exercise style term for all A options. This parameter is non-negotiable (“N”) in the present example and has a value (“A”) corresponding to American-style option exercise. Other possible values for this parameter include a value (“E”) corresponding to European-style exercise. In some embodiments, the value of this parameter may further define the exercise style. For example, a value of “E1” could correspond to a European-style option allowing exercise on the expiration date only, a value “E3” could correspond to a European-style option allowing exercise on the expiration date or on either of the two business days preceding the expiration date, etc.

FIG. 2B shows operations performed by system 100 in connection with receipt of orders for options conforming to the option A class definition. One or more parties may submit data 202 indicating a buy order for one or more A options. Each of those orders may indicate the class of option that the order submitter wishes to buy. In the current example, each buy order data block 202 indicates that the order submitter is available to receive an option in conformance with the option A class definition that is set forth in data 201. Each of the buy orders may further indicate a value for a negotiable term that the order submitter will accept. In the current example, each buy order data block 202 indicates a value for the strike price parameter (“SP”).

One or more parties may also submit data 203 indicating a sell order for one or more A options. Each of those orders may indicate the class of option that the order submitter wishes to sell and a value for a negotiable parameter that the order submitter will accept. In the current example, each sell order data block 203 indicates that the order submitter is available to grant an option in conformance with the option A class definition (set forth in data 201) and a value for the strike price parameter (“SP”) that the order submitter will accept.

The vertical ellipses in FIG. 2B indicate that additional buy order data 202 and sell order data 203 may also be received. As also shown in FIG. 2B, each of the buy order data 202 and sell order data 203 may include a unique identifier. For convenience, such identifiers are in the form “<IDB_>” and “<IDS_>.” Although the block representing option A class definition data 201 is reduced in size in FIG. 2B and in subsequent figures, this size reduction is not intended to indicate a change in the content of data 201.

FIG. 2C shows operations performed by system 100 in connection with matching of orders for options conforming to the option A class definition. In particular, system 100 identifies buy orders and sell orders that match based on values for a negotiable parameter. In the current example, system 100 has stored option A order book data 204 corresponding to the received buy order data 202 and sell order data 203 shown in FIG. 2B. Within data 204, system 100 identifies two pairs of buy and sell orders that match based on an indicated strike price value of 102. Specifically, buy order <IDB82> is matched with sell order <IDS31> and buy order <IDB86> is matched with sell order <IDS01>. In some embodiments, order data is stored by order books module 110 and matching may be performed by match engine module 106.

The vertical ellipses in FIG. 2C indicate that option A order book data 204 may include additional buy order data and additional sell order data, some or all of which may be matched. System 100 may perform matching in various ways. In some embodiments, for example, system 100 could match orders using a first-in first-out algorithm. If buy order <IDB86> was received prior to buy order <IDB82>, but after receipt of sell orders <IDS01> and <IDS31>, system 100 could match buy order <IDB86> to whichever of sell orders <IDS01> and <IDS31> is oldest. Other known matching algorithms could be adapted for use in connection with alternate-option order matching.

FIG. 2D shows operations performed by system 100 in connection with executed A options. In particular, system 100 transmits data indicating execution of A options corresponding to matched buy and sell orders. In the current example, system 100 transmits data 210 to the submitter of buy order <IDB82> indicating execution of an A option corresponding to that buy order, data 210 to the submitter of buy order <IDB86> indicating execution of an A option corresponding to that buy order, data 211 to the submitter of sell order <IDS01> indicating execution of an A option corresponding to that sell order, and data 211 to the submitter of sell order <IDS31> indicating execution of an A option corresponding to that sell order. The vertical ellipses in FIG. 2D indicate that system 100 may also transmit other data indicating execution of additional options. Although not shown in FIG. 2D, system 100 may store data (e.g., in clearinghouse module 140) indicating the executed A options and the parties to those executed A options.

Once executed, an alternate form option may be exercised, traded or otherwise handled in a manner similar to conventional exchange traded options. For example, the parties to an executed alternate-form option may never know each other's identity. If an option holder exercises an option that was executed as a result of matching with an order of a particular option seller, a different seller may be selected to fulfill the obligations of the option grantor. This can be further illustrated using the example of FIGS. 2C and 2D. A first A option was executed when buy order <IDB86> was matched with sell order <IDS01>. A second A option was executed when buy order <IDB82> was matched with sell order <IDS31>. Assume that the holder of the first A option (the submitter of buy order <IDB86>) exercises its A option. When that exercise occurs, system 100 (e.g., clearinghouse module 140) may select the grantor of the second A option (the submitter of sell order <IDS31>). Such selection could be performed randomly among all granted A option interests. System 100 could then create a pair of D delivery X futures contracts. A first of those contracts would have the exercising A option holder (the submitter of buy order <IDB86>) as the long counterparty and the exchange as the short counterparty. The second of those contracts would have the selected A option grantor (the submitter of sell order <IDS31>) as the short counterparty and the exchange as the long counterparty. The grantor of the first A option (the submitter of sell order <IDS01>) may subsequently be selected by system 100 if the holder of the second A option (the submitter of buy order <IDS82>) exercises or if another A option holder exercises, or may never be selected at all.

Holders of alternate-form options may also wish to liquidate their positions prior to exercise. In some embodiments, this may be facilitated by exchange trading of conventional options that are related to alternate form options. FIGS. 2E through 2H are additional block diagrams showing an example of this.

FIG. 2E shows operations performed by system 100 in connection with storing data 221 defining an A1 option class in addition to the previously described data 201 defining the A option class. In the present example, A1 options are similar to A options, but the premium parameter is negotiable and the strike price parameter is non-negotiable. Moreover, the strike price parameter has a defined value. In this example, that defined value is 102, the same value that formed the basis of the matched orders and executed options described in connection with FIGS. 2C and 2D. The block representing option A1 class definition data 204 is reduced in size in FIGS. 2F through 2H; this size reduction is not intended to indicate a change in the content of data 204.

FIG. 2F shows operations performed by system 100 in connection with receipt of orders for options conforming to the option A1 class definition. One or more parties may submit data 224 indicating a buy order for one or more A1 options. Each of those orders may indicate the class of option that the order submitter wishes to buy (A1 in the current example), may include a unique identifier (shown as “<IDb09” in the current example) and indicate a value for the negotiable premium parameter (“Pre(A1)”). The submitter of buy order data 224 shown in FIG. 2F may be the grantor of an A option. For example, if Pre(A1) is a value lower than Pre(A), the submitter of sell order <IDS31> may have submitted buy order <IDb09> so as to cash out the value represented by Pre(A)−Pre(A1). If Pre(A1) is a value higher than Pre(A), the submitter of sell order <IDS31> may have submitted buy order <IDb09> so as to limit loss to the value represented by Pre(A1)−Pre(A).

One or more other parties may submit data 225 indicating a sell order for one or more A1 options. Each of those orders may indicate the class of option that the order submitter wishes to sell (A1 in the current example), may include a unique identifier (shown as “<IDs62” in the current example) and indicate a value for the negotiable premium parameter (Pre(A)). The submitter of sell order data 225 shown in FIG. 2F may be the holder of an A option. For example, if Pre(A1) is a value higher than Pre(A), the submitter of buy order <IDB82> may have submitted sell order <IDs62> so as to cash out the value represented by Pre(A1)−Pre(A). If Pre(A1) is a value lower than Pre(A), the submitter of buy order <IDB82> may have submitted sell order <IDs62> so as to limit loss to the value represented by Pre(A)−Pre(A1).

The vertical ellipses in FIG. 2F indicate that additional buy order data 224 and sell order data 225 may also be received.

FIG. 2G shows operations performed by system 100 in connection with matching of orders for options conforming to the option A1 class definition. In the current example, system 100 has stored option A1 order book data 228 corresponding to the received buy order data 224 and sell order data 225 shown in FIG. 2F. Within data 228, system 100 identifies buy and sell orders that match based on an indicated premium value of Pre(A1). The vertical ellipses in FIG. 2G indicate that option A1 order book data may include additional buy order data and additional sell order data, some or all of which may also be matched.

FIG. 2H shows operations performed by system 100 in connection with executed A1 options. In particular, system 100 transmits data indicating execution of options corresponding to matched buy and sell orders for A1 options. In the current example, system 100 transmits data 231 to the submitter of buy order <IDb09> indicating execution of an A1 option corresponding to that buy order and data 231 to the submitter of sell order <IDs62> indicating execution of an A1 option corresponding to that sell order. The vertical ellipses in FIG. 2H indicate that system 100 may also transmit other data indicating execution of additional options. Although not shown in FIG. 2H, system 100 may store data (e.g., in clearinghouse module 140) indicating the executed A1 options and the parties to those executed A1 options.

For convenience, FIGS. 2A through 2H showed operations performed in a serial fashion. In some embodiments, system 100 may be simultaneously performing some of those operations. For example, while matching A option orders as shown in FIG. 2C, system 100 could simultaneously be receiving additional A option order data that may become the subject of subsequent matching. As another example, system 100 could be performing operations associated with A options while it is simultaneously performing operations associate with A1 options.

In the example of alternate-form option A class definition data 201, the strike price parameter was indicated as negotiable, the optioned transaction, premium, type, expiration and exercise style parameters were indicated as non-negotiable, and values were defined for the optioned transaction, premium, type, expiration and exercise style parameters. Definition data for other alternate-form option classes, and associated operations performed in conjunction therewith, may differ in other embodiments.

For example, in some embodiments the type term may be negotiable. Option class definition data may indicate that the type parameter is negotiable, may indicate that the optioned transaction, premium, expiration, strike price and exercise style parameters are non-negotiable, and may define values for the optioned transaction, premium, expiration, strike price and exercise style parameters. Values for the premium, expiration and strike price parameters may be defined in absolute or relative terms. Operations similar to those shown in FIGS. 2A through 2D may be performed, but with submitted orders indicating a type parameter value instead of a strike price parameter value. Operations similar those shown in FIGS. 2E through 2H may also be performed in connection with a related option class.

As another example, in some embodiments the expiration term may be negotiable. Option class definition data may indicate that the expiration parameter is negotiable, may indicate that the optioned transaction, premium, type, strike price and exercise style parameters are non-negotiable, and may define values for the optioned transaction, premium, type, strike price and exercise style parameters. Values for the premium and strike price parameters may be defined in absolute or relative terms. The option class definition data may also include data indicating whether orders for options conforming to the class definition should specify an expiration in absolute terms (e.g., a specific date and/or a specific hour on a specific date) or relative terms (e.g., as an incremental amount of time after an option conforming to the class definition is executed). Operations similar to those shown in FIGS. 2A through 2D may be performed, but with submitted orders indicating an expiration parameter value instead of a strike price parameter value. Operations similar those shown in FIGS. 2E through 2H may also be performed in connection with a related option class.

As yet another example, in some embodiments the optioned transaction term may be negotiable. For instance, an option class may specify that the optioned transaction is a futures contract for a specified commodity, but the delivery date may be negotiable by parties seeking to obtain (or grant) an option. The option class definition data may indicate that the optioned transaction parameter is negotiable, may indicate that the premium, type, expiration, strike price and exercise style parameters are non-negotiable, and may define values for the premium, type, expiration, strike price and exercise style parameters. Values for the premium, expiration and strike price parameters may be defined in absolute or relative terms. Operations similar to those shown in FIGS. 2A through 2D may be performed, but with submitted orders indicating an optioned transaction parameter value (e.g., a delivery date for the futures contract that will be created if an option is exercised) instead of a strike price parameter value. Operations similar those shown in FIGS. 2E through 2H may also be performed in connection with a related option class.

As but a further example, in some embodiments the exercise style term may be negotiable. Option class definition data may indicate that the exercise style parameter is negotiable, may indicate that the optioned transaction, premium, type, expiration and strike price parameters are non-negotiable, and may define values for the optioned transaction, premium, type, expiration and strike price parameters. Values for the premium, expiration and strike price parameters may be defined in absolute or relative terms. Operations similar to those shown in FIGS. 2A through 2D may be performed, but with submitted orders indicating an exercise style parameter value instead of a strike price parameter value. Operations similar those shown in FIGS. 2E through 2H may also be performed in connection with a related option class.

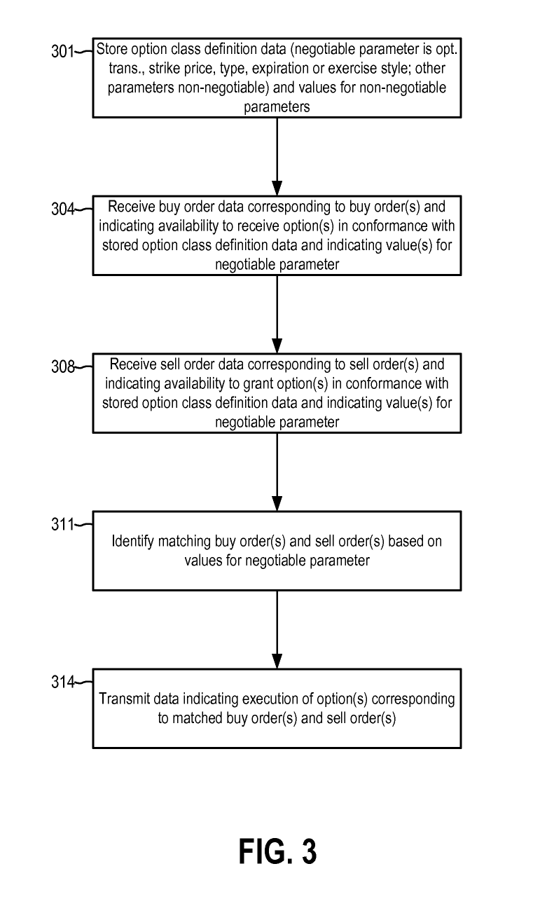

FIG. 3 is a flow chart showing operations performed in methods according to some embodiments. The flow chart of FIG. 3 encompasses various operations described in connection with FIGS. 2A through 2D, as well as operations performed in connection with other embodiments. In some embodiments, the operations of FIG. 3 are performed by exchange computer system 100. In other embodiments, the operations of FIG. 3 may be carried out by another type of computer system.

In block 301, a computer system stores definition data for a class of alternate-form options. The stored option class definition data indicates a negotiable parameter, a plurality of non-negotiable parameters, and values for the non-negotiable parameters. The negotiable parameter may be a single parameter. That single parameter may be from a parameter group that consists of an optioned transaction parameter, a strike price parameter, a put-or-call type parameter, an expiration parameter and an exercise style parameter. The non-negotiable parameter may include a premium parameter and members of the parameter group that are not the negotiable parameter.

In block 304, the computer system receives buy order data corresponding to one or more buy orders. Each of the buy order data may indicate availability of an ordering party to receive an option in conformance with the option class definition data and may further indicate a value for the negotiable parameter. In block 308, the computer system receives sell order data corresponding to one or more sell orders. Each of the sell order data may indicate availability of an ordering party to grant an option in conformance with the option class definition data and may further indicate a value for the negotiable parameter. The operations of block 308 could occur prior to or simultaneously with operations of block 304. In block 311, the computer system identifies matching buy and sell orders based on values for the negotiable parameter indicated by matched buy and sell orders. In block 314, the computer system transmits data indicating execution of options corresponding to the matched buy and sell orders.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that some steps illustrated in the figures may be performed in other than the recited order, and that one or more steps illustrated may be omitted in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
storing, by a computer system, option class definition data indicating a negotiable parameter, a plurality of non-negotiable parameters and values for the non-negotiable parameters, wherein
the negotiable parameter is a parameter from a parameter group that consists of an optioned transaction parameter, a strike price parameter, a put-or-call type parameter, an expiration parameter and an exercise style parameter, and
the non-negotiable parameters include a premium parameter and the members of the parameter group that are not the negotiable parameter;
receiving buy order data at the computer system, each of the buy order data corresponding to a buy order and indicating availability to receive an option in conformance with the option class definition data and a value for the negotiable parameter;
receiving sell order data at the computer system, each of the sell order data corresponding to a sell order and indicating availability to grant an option in conformance with the option class definition data and a value for the negotiable parameter;
identifying, by the computer system, matching buy orders and sell orders based on the values for the negotiable parameter indicated by the buy order data and the sell order data; and
transmitting, by the computer system, data indicating execution of options corresponding to the matched buy orders and sell orders.

2. The method of claim 1, wherein the negotiable parameter is the strike price parameter and the non-negotiable parameters include the optioned transaction parameter, the put-or-call type parameter, the expiration parameter and the exercise style parameter.

3. The method of claim 1, wherein the negotiable parameter is the put-or-call type parameter and the non-negotiable parameters include the optioned transaction parameter, the strike price parameter, the expiration parameter and the exercise style parameter.

4. The method of claim 1, wherein the negotiable parameter is the expiration parameter and the non-negotiable parameters include the optioned transaction parameter, the strike price parameter, the put-or-call type parameter and the exercise style parameter.

5. The method of claim 1, wherein the negotiable parameter is the exercise style parameter and the non-negotiable parameters include the optioned transaction parameter, the strike price parameter, the put-or-call type parameter and the expiration parameter.

6. The method of claim 1, wherein values for the non-negotiable parameters include an absolute value for the premium parameter and a relative value for at least one of the strike price parameter and the expiration parameter.

7. The method of claim 1, wherein values for the non-negotiable parameters include an absolute value for the premium parameter and relative values for the strike price parameter and the expiration parameter.

8. The method of claim 1, further comprising:
storing, by the computer system, additional option class definition data indicating values for an optioned transaction parameter, a type parameter, an expiration parameter, a strike price parameter and an exercise style parameter that are respectively the same as values for the optioned transaction parameter, the type parameter, the expiration parameter, the strike price parameter and the exercise style parameter associated with at least one of the executed options, the additional option class definition data further indicating a negotiable premium parameter;
receiving additional buy order data at the computer system, each of the additional buy order data corresponding to an additional buy order and indicating availability to receive an option in conformance with the additional option class definition data and a value for the negotiable premium parameter;
receiving additional sell order data at the computer system, each of the additional sell order data corresponding to an additional sell order and indicating availability to grant an option in conformance with the additional option class definition data and a value for the negotiable premium parameter;
identifying, by the computer system, matching additional buy orders and additional sell orders based on the values for the negotiable premium parameter indicated by the additional buy order data and the additional sell order data; and
transmitting, by the computer system, data indicating execution of options corresponding to the matched additional buy orders and additional sell orders.

9. One or more non-transitory computer-readable media storing computer executable instructions that, when executed, cause a computer system to perform operations that include:
storing option class definition data indicating a negotiable parameter, a plurality of non-negotiable parameters and values for the non-negotiable parameters, wherein
the negotiable parameter is a parameter from a parameter group that consists of an optioned transaction parameter, a strike price parameter, a put-or-call type parameter, an expiration parameter and an exercise style parameter, and
the non-negotiable parameters include a premium parameter and the members of the parameter group that are not the negotiable parameter;
receiving buy order data, each of the buy order data corresponding to a buy order and indicating availability to receive an option in conformance with the option class definition data and a value for the negotiable parameter;
receiving sell order data, each of the sell order data corresponding to a sell order and indicating availability to grant an option in conformance with the option class definition data and a value for the negotiable parameter;
identifying matching buy orders and sell orders based on the values for the negotiable parameter indicated by the buy order data and the sell order data; and
transmitting data indicating execution of options corresponding to the matched buy orders and sell orders.

10. The one or more non-transitory computer-readable media of claim 9, wherein the negotiable parameter is the strike price parameter and the non-negotiable parameters include the optioned transaction parameter, the put-or-call type parameter, the expiration parameter and the exercise style parameter.

11. The one or more non-transitory computer-readable media of claim 9, wherein the negotiable parameter is the put-or-call type parameter and the non-negotiable parameters include the optioned transaction parameter, the strike price parameter, the expiration parameter and the exercise style parameter.

12. The one or more non-transitory computer-readable media of claim 9, wherein the negotiable parameter is the expiration parameter and the non-negotiable parameters include the optioned transaction parameter, the strike price parameter, the put-or-call type parameter and the exercise style parameter.

13. The one or more non-transitory computer-readable media of claim 9, wherein the negotiable parameter is the exercise style parameter and the non-negotiable parameters include the optioned transaction parameter, the strike price parameter, the put-or-call type parameter and the expiration parameter.

14. The one or more non-transitory computer-readable media of claim 9, wherein values for the non-negotiable parameters include an absolute value for the premium parameter and a relative value for at least one of the strike price parameter and the expiration parameter.

15. The one or more non-transitory computer-readable media of claim 9, wherein values for the non-negotiable parameters include an absolute value for the premium parameter and relative values for the strike price parameter and the expiration parameter.

16. The one or more non-transitory computer-readable media of claim 9, wherein the stored instructions further comprise instructions that, when executed, cause the computer system to perform operations that include:
storing additional option class definition data indicating values for an optioned transaction parameter, a type parameter, an expiration parameter, a strike price parameter and an exercise style parameter that are respectively the same as values for the optioned transaction parameter, the type parameter, the expiration parameter, the strike price parameter and the exercise style parameter associated with at least one of the executed options, the additional option class definition data further indicating a negotiable premium parameter;
receiving additional buy order data, each of the additional buy order data corresponding to an additional buy order and indicating availability to receive an option in conformance with the additional option class definition data and a value for the negotiable premium parameter;
receiving additional sell order data, each of the additional sell order data corresponding to an additional sell order and indicating availability to grant an option in conformance with the additional option class definition data and a value for the negotiable premium parameter;
identifying matching additional buy orders and additional sell orders based on the values for the negotiable premium parameter indicated by the additional buy order data and the additional sell order data; and
transmitting data indicating execution of options corresponding to the matched additional buy orders and additional sell orders.

17. A computer system comprising:
at least one processor; and
at least one non-transitory memory, wherein the at least one non-transitory memory stores instructions that, when executed, cause the computer system to perform operations that include
storing option class definition data indicating a negotiable parameter, a plurality of non-negotiable parameters and values for the non-negotiable parameters, wherein
the negotiable parameter is a parameter from a parameter group that consists of an optioned transaction parameter, a strike price parameter, a put-or-call type parameter, an expiration parameter and an exercise style parameter, and
the non-negotiable parameters include a premium parameter and the members of the parameter group that are not the negotiable parameter,
receiving buy order data, each of the buy order data corresponding to a buy order and indicating availability to receive an option in conformance with the option class definition data and a value for the negotiable parameter,
receiving sell order data, each of the sell order data corresponding to a sell order and indicating availability to grant an option in conformance with the option class definition data and a value for the negotiable parameter,
identifying matching buy orders and sell orders based on the values for the negotiable parameter indicated by the buy order data and the sell order data, and
transmitting data indicating execution of options corresponding to the matched buy orders and sell orders.

18. The computer system of claim 17, wherein the negotiable parameter is the strike price parameter and the non-negotiable parameters include the optioned transaction parameter, the put-or-call type parameter, the expiration parameter and the exercise style parameter.

19. The computer system of claim 17, wherein the negotiable parameter is the put-or-call type parameter and the non-negotiable parameters include the optioned transaction parameter, the strike price parameter, the expiration parameter and the exercise style parameter.

20. The computer system of claim 17, wherein the negotiable parameter is the expiration parameter and the non-negotiable parameters include the optioned transaction parameter, the strike price parameter, the put-or-call type parameter and the exercise style parameter.

21. The computer system of claim 17, wherein the negotiable parameter is the exercise style parameter and the non-negotiable parameters include the optioned transaction parameter, the strike price parameter, the put-or-call type parameter and the expiration parameter.

22. The computer system of claim 17, wherein values for the non-negotiable parameters include an absolute value for the premium parameter and a relative value for at least one of the strike price parameter and the expiration parameter.

23. The computer system of claim 17, wherein values for the non-negotiable parameters include an absolute value for the premium parameter and relative values for the strike price parameter and the expiration parameter.

24. The computer system of claim 17, wherein the stored instructions further comprise instructions that, when executed, cause the computer system to perform operations that include
storing additional option class definition data indicating values for an optioned transaction parameter, a type parameter, an expiration parameter, a strike price parameter and an exercise style parameter that are respectively the same as values for the optioned transaction parameter, the type parameter, the expiration parameter, the strike price parameter and the exercise style parameter associated with at least one of the executed options, the additional option class definition data further indicating a negotiable premium parameter,
receiving additional buy order data, each of the additional buy order data corresponding to an additional buy order and indicating availability to receive an option in conformance with the additional option class definition data and a value for the negotiable premium parameter,
receiving additional sell order data, each of the additional sell order data corresponding to an additional sell order and indicating availability to grant an option in conformance with the additional option class definition data and a value for the negotiable premium parameter,
identifying matching additional buy orders and additional sell orders based on the values for the negotiable premium parameter indicated by the additional buy order data and the additional sell order data, and
transmitting data indicating execution of options corresponding to the matched additional buy orders and additional sell orders.
